(19) United States
(12) Patent Application Publication
(10) Pub. No.: US 2025/0236703 A1
(43) Pub. Date: Jul. 24, 2025

(54) METHOD FOR PRODUCING POLYESTER COPOLYMER USING REUSED BIS-2-HYDROXYETHYL TEREPHTHALATE

(71) Applicant: SK CHEMICALS CO., LTD., Gyeonggi-do (KR)

(72) Inventors: Da-Young HWANG, Gyeonggi-do (KR); Yoo Jin LEE, Gyeonggi-do (KR)

(21) Appl. No.: 18/697,793

(22) PCT Filed: Oct. 26, 2022
(86) PCT No.: PCT/KR2022/016422

§ 371 Date: Apr. 2, 2024

(30) Foreign Application Priority Data
Nov. 17, 2021 (KR) 10-2021-0158357

(51) Int. Cl. C08G 63/672; C08G 63/80; C08G 63/81

(52) U.S. Cl. CPC C08G 63/672; C08G 63/80; C08G 63/81

(57) ABSTRACT

The preparation method of polyester copolymer according to the present disclosure uses recycled bis-2-hydroxyethyl terephthalate, and simultaneously, controls the discharge amounts of by-products during the preparation process of polyester copolymer, thereby improving the quality of polyester copolymer, and increasing the efficiency of the preparation process.

### TECHNICAL FIELD

the present disclosure relates to a method for preparing polyester copolymer using recycled bis-2-hydroxyethyl terephthalate.

### BACKGROUND ART

Polyester has excellent mechanical strength, heat resistance, transparency and gas barrier property, and thus, is most suitable as material of beverage containers, packaging films, audio/video films, and the like, and is being used in large quantities. Further, it is being widely produced worldwide as industrial material such as medical fiber or tire cord, and the like. Since a polyester sheet or plate has good transparency and excellent mechanical strength, it is being widely used as materials of cases, boxes, store shelves, protection panels, blister packaging, building materials, interior and exterior materials, and the like.

Meanwhile, as waste plastic responsible for about 70% of marine pollution has become a serious social problem, every country regulates the use of disposable plastic, and simultaneously, plans to reuse waste plastic. A method for reusing waste plastic may be largely classified in two methods, one collects, grinds and cleans waste plastic, followed by melt extrusion and re-pelletization, and uses it as raw material, and the other uses material obtained by depolymerization of waste plastic as monomers for synthesis of plastic. In the latter case, bis-2-hydroxyethyl terephthalate may be obtained by depolymerization of PET or PETG among waste plastic, and using the same as monomers of polyester copolymer is being studied.

However, due to foreign substances in waste plastic, it is difficult to obtain satisfactory material, and particularly, plastic prepared from material obtained by depolymerization of waste plastic often generates quality deterioration. Particularly, in case the quality of plastic is degraded, quality deterioration of the products prepared by extrusion may be inevitable.

Thus, the inventors confirmed that by using recycled bis-2-hydroxyethyl terephthalate as monomers of polyester copolymer, and simultaneously, pre-treating recycled bis-2-hydroxyethyl terephthalate as described below and using it for polymerization, and controlling the discharge amounts of by-products in esterification reaction and polycondensation reaction, the quality of polyester copolymer can be improved, and the efficiency of the preparation process can be increased, and completed the present disclosure.

### DISCLOSURE

### Technical Problem

It is an object of the present disclosure to provide a method for preparing polyester copolymer that uses recycled monomers, and can improve the quality of polyester copolymer and increase efficiency of the preparation process, and polyester copolymer prepared thereby.

### Technical Solution

In order to achieve the object, there is provided herein a method for preparing polyester copolymer comprising steps of:
1) mixing bis-2-hydroxyethyl terephthalate and water at a temperature of 60 to 120° C. and a pressure of 0.5 to 3.5 kg/cm² to prepare an aqueous solution of bis-2-hydroxyethyl terephthalate (step 1);
2) subjecting the following components to an esterification reaction to prepare oligomer (step 2);
   i) the aqueous solution comprising bis-2-hydroxyethyl terephthalate of step 1,
   ii) dicarboxylic acid or derivatives thereof,
   iii) ethylene glycol or diethylene glycol, and
   iv) diol-based comonomers; and
3) conducting polycondensation of the oligomer of step 2 to prepare polyester copolymer (step 3),
wherein the amounts of by-products discharged in the steps 2 and 3 meet the following Mathematical Formula 1:

0.30≤A/(A+B)≤0.85 [Mathematical Formula 1]
in the Mathematical Formula 1,
A is the volume (mL) of the by-products discharged in the step 2, and
B is the volume (mL) of the by-products discharged in the step 3.

The present disclosure relates to polyester copolymer prepared by copolymerization of dicarboxylic acid or derivatives thereof, ethylene glycol or diethylene glycol and diol-based comonomers, wherein recycled bis-2-hydroxyethyl terephthalate participates in the reaction during the copolymerization process.

Since recycled bis-2-hydroxyethyl terephthalate is material recycled once, there is a concern about quality deterioration of polyester copolymer. Thus, in the present disclosure, recycled bis-2-hydroxyethyl terephthalate in the form of powder is prepared into a homogeneous solution, thus securing uniformity of recycled bis-2-hydroxyethyl terephthalate and reaction efficiency, thereby improving economic feasibility and productivity.

Further, the present disclosure is to control discharge amounts of by-products in each of the esterification reaction and polycondensation reaction, so as to improve the quality of the finally prepared polyester copolymer.

Hereinafter, the present disclosure will be explained in detail according to steps.

### (Step 1)

The step 1 is a step wherein bis-2-hydroxyethyl terephthalate in the form of powder is dissolved in water to prepare an aqueous solution of bis-2-hydroxyethyl terephthalate.

The term ‘recycled bis-2-hydroxyethyl terephthalate’ used herein means material obtained from waste plastic recovered after used. As the waste plastic from which the bis-2-hydroxyethyl terephthalate can be obtained, PET and PETG, and the like may be mentioned. For example, bis-2-hydroxyethyl terephthalate can be obtained from PEG recovered after used, by glycolysis, hydrolysis, methanolysis, and the like, and such methods are well known in the art.

Since the recycled bis-2-hydroxyethyl terephthalate passes through various chemical steps during the process of obtaining it from waste plastic, in case it is used as monomers of copolymer, product quality may be inevitably deteriorated. Particularly, in case it is used as monomers of polyester copolymer, color quality may be deteriorated, and a large quantity of by-products may be generated as described below.

Thus, in the present disclosure, the recycled bis-2-hydroxyethyl terephthalate is used as the main monomers constituting polyester copolymer, but the recycled bis-2-hydroxyethyl terephthalate is dissolved in water and prepared as a homogeneous solution. In general, recycled bis-2-hydroxyethyl terephthalate is prepared in the form of powder, but in case it is used for polymerization as it is, it may be difficult to secure reaction efficiency, thus having an adverse influence on the quality of the finally prepared polyester copolymer. Thus, in the present disclosure, bis-2-hydroxyethyl terephthalate and water are mixed at a temperature of 60 to 120° C. and a pressure of 0.5 to 3.5 kg/cm² to prepare an aqueous solution of bis-2-hydroxyethyl terephthalate, which is used for polymerization.

The step 1 is conducted at 60 to 120° C. If the temperature is less than 60° C., recycled bis-2-hydroxyethyl terephthalate may not be sufficiently dissolved, and if the temperature is greater than 120° C., there is a concern about thermal decomposition of bis-2-hydroxyethyl terephthalate.

Preferably, the concentration of the bis-2-hydroxyethyl terephthalate aqueous solution prepared in the step 1 is 50 to 95%. If the concentration is less than 50%, the amount of water used for polymerization may increase, and thus, there is a concern about increase in by-products in the steps 2 and 3 described below. Further, if the concentration is greater than 95%, due to too high concentration, it may be difficult to secure homogeneity. More preferably, the concentration of the bis-2-hydroxyethyl terephthalate aqueous solution prepared in the step 1 is 55% or more, or 60% or more, and 90% or less, or 85% or less.

### (Step 2)

The step 2 is a step wherein the aqueous solution comprising bis-2-hydroxyethyl terephthalate of step 1, and monomers of polyester copolymer are subjected to an esterification reaction to prepare oligomer.

In the esterification reaction, in addition to the aqueous solution comprising bis-2-hydroxyethyl terephthalate of step 1, dicarboxylic acid or derivatives thereof, ethylene glycol or diethylene glycol, and diol-based comonomers are used, and each component will be specifically explained below.

### (Dicarboxylic Acid or Derivatives Thereof)

Dicarboxylic acid or derivatives thereof used herein mean main monomers constituting polyester copolymer, and is referred to as ‘the second component’ herein for convenience. Particularly, the dicarboxylic acid comprises terephthalic acid or isophthalic acid, and by the terephthalic acid and isophthalic acid, the properties such as heat resistance, chemical resistance, weather resistance, and the like, of the polyester copolymer according the present disclosure may be improved. Further, the terephthalic acid derivatives may be terephthalic acid alkyl ester, preferably dimethyl terephthalic acid.

The dicarboxylic acid may further comprise an aromatic dicarboxylic acid component, an aliphatic dicarboxylic acid component, or a mixture thereof, besides terephthalic acid. In this case, it is preferable that dicarboxylic acid other than terephthalic acid may be included in the content of 1 to 30 wt %, based on the total weight of total dicarboxylic acid components.

The aromatic dicarboxylic acid component may be C8-20, preferably C8-14 aromatic dicarboxylic acid or a mixture thereof. Examples of the aromatic dicarboxylic acid may include isophthalic acid, naphthalenedicarboxylic acid such as 2,6-naphthalenedicarboxylic acid, and the like, diphenyl dicarboxylic acid, 4,4′-stilbenedicarboxylic acid, 2,5-furandicarboxylic acid, 2,5-thiophenedicarboxylic acid, and the like, but specific examples of the aromatic dicarboxylic acid are not limited thereto. The aliphatic dicarboxylic acid component may be a C4-20, preferably C4-12 aliphatic dicarboxylic acid component or a mixture thereof. Examples of the aliphatic dicarboxylic acid may include cyclohexanedicarboxylic acid such as 1,4-cyclohexanedicarboxylic acid, 1,3-cyclohexanedicarboxylic acid, and the like, linear, branched or cyclic aliphatic dicarboxylic acid components such as phthalic acid, sebacic acid, succinic acid, isodecylsuccinic acid, maleic acid, fumaric acid, adipic acid, glutaric acid and azelaic acid, and the like, but specific examples of the aliphatic dicarboxylic acid are not limited thereto.

### (Ethylene Glycol and Diethylene Glycol)

The ethylene glycol and diethylene glycol are components contributing to improvement in transparency and impact resistance of polyester copolymer, and are referred to as ‘the third component’ herein for convenience. Preferably, the ethylene glycol and diethylene glycol are used in an amount of 5 to 100 moles, when the sum of the third component and the fourth component described below is 100 moles.

### (Diol-Based Comonomers)

The polyester copolymer of the present disclosure additionally comprises diol-based comonomers, besides the above explained ethylene glycol and diethylene glycol, and preferably comprises cyclohexanedimethanol, cyclohexanedimethanol derivatives, or isosorbide.

The cyclohexanedimethanol (for example, 1,2-cyclohexanedimethanol, 1,3-cyclohexanedimethanol or 1,4-cyclohexanedimethanol) and cyclohexanedimethanol derivatives are components contributing to improvement in transparency and impact resistance of prepared polyester copolymer. Preferably, the cyclohexanedimethanol and cyclohexanedimethanol derivatives are used in an amount of 5 to 90 moles, when the sum of the third component and diol-based comonomers is 100 moles.

Preferably, the cyclohexanedimethanol derivative is 4-(hydroxymethyl)cyclohexylmethyl 4-(hydroxymethyl)cyclohexane carboxylate, or 4-(4-(hydroxymethyl)cyclohexylmethoxymethyl)cyclohexylmethanol.

The isosorbide is used to improve processability of prepared polyester copolymer. Although transparency and impact resistance of polyester copolymer are improved by the above explained cyclohexanedimethanol and ethylene glycol or diethylene glycol, shear flow property should be improved and crystallization speed should be delayed for processability, but it is difficult to achieve such effects only by cyclohexanedimethanol and ethylene glycol or diethylene glycol. Thus, in case isosorbide is included, shear flow property may be improved and crystallization speed may be delayed while maintaining transparency and impact resistance, thereby improving processability of prepared polyester copolymer. Preferably, the isosorbide is used in an amount of 0.1 to 50 moles, when the sum of the third component and diol-based monomers is 100 moles.

Further, the diol-based comonomers may further comprise other diol-based comonomers, besides cyclohexanedimethanol, cyclohexanedimethanol derivatives, and isosorbide, and as the examples, 1,2-propanediol, 1,3-propanediol, 2-methyl-1,3-propanediol, 2-methylene-1,3-propanediol, 2-ethyl-1,3-propanediol, 2-isopropyl-1,3-propanediol, 2,2-dimethyl-1,3-propanediol, 1,4-butanediol, 2,3-butanediol, 3-methyl-1,5-pentanediol, 3-methyl-2,4-pentanediol, 1,6-hexanediol, 1,2-cyclohexanediol, or 1,4-cyclohexanediol may be mentioned.

### (Esterification Reaction)

The esterification reaction of the step 2 may be conducted at a pressure of 0.5 to 3.5 kg/cm² and a temperature of 200 to 300° C. The esterification reaction conditions may be appropriately controlled according to specific properties of prepared polyester, component ratio, or process conditions, and the like. Specifically, preferable examples of the esterification reaction conditions may include a temperature of 240 to 295° C., more preferably 245 to 275° C.

Further, the esterification reaction may be conducted batch wise or continuously, and the raw materials may be separately introduced, but it is preferable to introduce in the form of slurry in which all the components are mixed. Further, a diol component such as isosorbide that is solid at room temperature may be dissolved in water or ethylene glycol, and then, mixed with dicarboxylic acid components such as terephthalic acid to form a slurry. Alternatively, after isosorbide is molten at 60° C. or more, it may be mixed with dicarboxylic acid components such as terephthalic acid and other diol components to form a slurry. Further, water may be additionally introduced in the mixed slurry to assist in increase in the flowability of the slurry.

Preferably, the esterification reaction of the step 2 is conducted for 2 to 10 hours. The reaction time has an influence on the quality of the finally produced polyester copolymer, and in case the reaction time is less than 2 hours or greater than 10 hours, color quality of the finally produced polyester copolymer may be deteriorated.

Meanwhile, the esterification reaction may be conduced using a catalyst comprising a titanium-based compound, a germanium-based compound, an antimony-based compound, an aluminum-based compound, a tin-based compound or a mixture thereof.

As examples of the titanium-based compound, tetraethyl titanate, acetyltripropyl titanate, tetrapropyl titanate, tetrabutyl titanate, 2-ethylhexyl titanate, octylene glycol titanate, lactate titanate, triethanolamine titanate, acetylacetonate titanate, ethylacetoaceticester titanate, isostearyl titanate, titanium dioxide, and the like may be mentioned. As examples of the germanium-based compound, germanium dioxide, germanium tetrachloride, germanium ethylene glycoxide, germanium acetate, a copolymer using them, or a mixture thereof, and the like may be mentioned. Preferably, germanium dioxide may be used, and as such germanium dioxide, both crystalline or amorphous germanium dioxide may be used, and glycol-solubles may also be used.

Further, in the esterification reaction process of the step 2, by-products may be discharged. In the by-products, unreacted monomers and water by-products resulting from the esterification reaction are included. A method for discharging the by-products is not specifically limited, and for example, by-products may be discharged from the lower part of the reactor where the esterification reaction occurs, and the discharge amount may be controlled.

Particularly, by controlling the amounts of by-products discharged in the esterification reaction of the step 2 and the polycondensation reaction of step 3 described below, the quality of the finally prepared polyester copolymer may be improved, which will be explained later.

### (Step 3)

The step 3 is a step wherein the oligomer prepared in the step 2 is subjected to polycondensation to prepare polyester copolymer.

It is preferable that the polycondensation reaction is conducted at a temperature of 240 to 300° C. and a pressure of 400 to 0.01 mmHg. Further, it is preferable that the polycondensation reaction is conducted for 1 to 10 hours. By applying the polycondensation reaction temperature and pressure conditions, by-products of the polycondensation reaction may be removed outside the system. Further, when applying the polycondensation reaction time, intrinsic viscosity of the final product may reach an appropriate level.

Meanwhile, after the polycondensation reaction is completed, polyester copolymer is recovered, and at this time, by-products may be recovered together, and the amount of recovered by-products may be confirmed. Since by-products have been previously discharged in the esterification reaction of step 2, the amount of by-products discharged in step 3 is also controlled, and the amount of each discharged by-products meets the requirement of Mathematical Formula 1 as explained above.

Specifically, unlike the Mathematical Formula 1, in case the amount of by-products discharged in step 2 is less than 30% of the total amount of discharged by-products, since the by-products may remain in step 2 and step 3, reaction may not be sufficiently progressed, and thus, productivity may be deteriorated and the quality of prepared polyester copolymer may be deteriorated. Further, in case the amount of by-products discharged in step 2 is greater than 85% of the total amount of discharged by-products, excessive monomer loss may be generated, and thus, the reaction may not be sufficiently progressed, and productivity may be deteriorated and the quality of prepared polyester copolymer may be deteriorated.

Meanwhile, according to the preparation method of the present disclosure, solid-state polymerization may be further conducted as necessary, after the step 3. The solid-state polymerization is intended to increase the molecular weight of the polyester copolymer prepared in the step 3, and may be preferably conducted at 150 to 220° C., and the reaction time may be controlled until intended molecular weight is achieved.

Further, according to the present disclosure, there is also provided polyester copolymer prepared by the preparation method of polyester copolymer as explained above.

The polyester copolymer according to the present disclosure has intrinsic viscosity of 0.50 to 1.0 dl/g, preferably 0.50 to 0.85 dl/g, more preferably 0.55 to 0.80 dl/g. The measurement method of intrinsic viscosity will be explained in examples later.

Further, the polyester copolymer comprises repeat units derived from bis-2-hydroxyethyl terephthalate in the content of 5 wt % to 99 wt %, more preferably 10 wt % to 90 wt %, based on the weight of the polyester copolymer.

### Advantageous Effects

As explained, according to the present disclosure, by using recycled bis-2-hydroxyethyl terephthalate, and simultaneously, controlling the amounts of by-products discharged in the preparation process of polyester copolymer, the quality of polyester copolymer may be improved, and the efficiency of the preparation process may be increased.

### MODE FOR INVENTION

Hereinafter, preferable examples will be presented for better understanding of the present disclosure. However, these examples are presented only for better understanding of the present disclosure, and the scope of the present disclosure is not limited thereby.

### Example 1

Step 1) Preparation of r-BHET Solution

Recycled bis-2-hydroxyethyl terephthalate (1468.3 g; hereinafter referred to as ‘r-BHET’) and water (163.1 g) were uniformly mixed at atmospheric pressure (absolute pressure: 760.0 mmHg) and 85° C. to prepare a r-BHET solution (90 wt %).

### Step 2) Esterification Reaction

Into a reactor with a capacity of 10 L in which a column, and a condenser capable of cooling by water are connected, the above prepared r-BHET solution, and as monomers, TPA(terephthalic acid; 2239.1 g), EG(ethylene glycol; 543.6 g), CHDM(1,4-cyclohexanedimethanol; 277.5 g), ISB(isosorbide; 98.5 g) and DEG(diethylene glycol; 28.1 g) were introduced. Further, GeO₂ (9.9 g) was introduced as a catalyst, phosphoric acid (1.5 g) as a stabilizer, Polysynthren Blue RLS(Clarient, 0.004 g) as blue toner, and Solvaperm Red BB(Clarient, 0.002 g) as red toner.

Subsequently, nitrogen was introduced in the reactor to make a pressurized state where the pressure of the reactor is 1.0 kgf/cm² higher than atmospheric pressure (absolute pressure: 1495.6 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 372 mL, the valve was closed so that by-products may not be additionally discharged in the esterification reaction. As described below, the amount (372 mL) of discharged by-products was the amount controlled to 50% of the total amount of discharged by-products in the total reaction (esterification reaction of step 2 and polycondensation reaction of step 3) of Example 1.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor was lowered from atmospheric pressure state to 5 Torr (absolute pressure: 5 mmHg) over 30 minutes, and simultaneously, the temperature of the reactor was raised to 280° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.70 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 372 mL.

### Step 4) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 200° C. at a speed of 40° C./hour, and maintained at 200° C. The solid-state polymerization reaction was progressed until the intrinsic viscosity (IV) of the particles in the reactor became 1.0 dl/g, thus preparing polyester copolymer.

### Example 2

Step 1) Preparation of r-BHET Solution

r-BHET (4980.6 g) and water (1245.2 g) were uniformly mixed at a pressure 0.5 kgf/cm² higher than atmospheric pressure (absolute pressure: 1127.8 mmHg) and 90° C. to prepare a r-BHET solution (80 wt %).

### Step 2) Esterification Reaction

Into a reactor with a capacity of 10 L in which a column, and a condenser capable of cooling by water are connected, the above prepared r-BHET solution, and as monomers, EG(24.3 g), CHDM(112.9 g), ISB(57.3 g), DEG(57.3 g) were introduced. Further, GeO₂ (14.8 g) was introduced as a catalyst, phosphoric acid(0.8 g) as a stabilizer, Polysynthren Blue RLS(Clarient, 0.012 g) as blue toner, and Solvaperm Red BB(Clarient, 0.006 g) as red toner.

Subsequently, nitrogen was introduced in the reactor to make a pressurized state where the pressure of the reactor is 2.0 kgf/cm² higher than atmospheric pressure (absolute pressure: 2231.1 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 405 mL, the valve was closed so that by-products may not be additionally discharged in the esterification reaction. As described below, the amount (405 mL) of discharged by-products was the amount controlled to 30% of the total amount of discharged by-products in the total reaction (esterification reaction of step 2 and polycondensation reaction of step 3) of Example 2.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 280° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.60 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 945 mL.

### Step 4) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 200° C. at a speed of 40° C./hour, and maintained at 200° C. The solid-state polymerization reaction was progressed until the intrinsic viscosity (IV) of the particles in the reactor became 0.85 dl/g, thus preparing polyester copolymer.

### Example 3

Step 1) Preparation of r-BHET Solution

r-BHET (3967.1 g) and water (208.8 g) were uniformed mixed at a pressure 2.0 kgf/cm² higher than atmospheric pressure (absolute pressure: 2231.1 mmHg) and 120° C. to prepare a r-BHET solution (95 wt %).

### Step 2) Esterification Reaction

Into a reactor with a capacity of 10 L in which a column, and a condenser capable of cooling by water are connected, the above prepared r-BHET solution, and as monomers, TPA(864.2 g), EG(38.7 g), CHDM(60.0 g), DEG(152.0 g) were introduced. Further, TiO₂/SiO₂ copolymer (0.4 g) was introduced as a catalyst, phosphoric acid (0.4 g) as a stabilizer, Polysynthren Blue RLS(Clarient, 0.016 g) as blue toner, and Solvaperm Red BB(Clarient, 0.004 g) as red toner.

Subsequently, nitrogen was introduced in the reactor to make a pressurized state where the pressure of the reactor is 0.5 kgf/cm² higher than atmospheric pressure (absolute pressure: 1127.8 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 337 mL, the valve was closed so that by-products may not be additionally discharged in the esterification reaction. As described below, the amount (337 mL) of discharged by-products was the amount controlled to 35% of the total amount of discharged by-products in the total reaction (esterification reaction of step 2 and polycondensation reaction of step 3) of Example 3.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 275° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.60 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 626 mL.

### Step 4) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 210° C. at a speed of 40° C./hour, and maintained at 210° C. The solid-state polymerization reaction was progressed until the intrinsic viscosity (IV) of the particles in the reactor became 0.80 dl/g, thus preparing polyester copolymer.

### Example 4

Step 1) Preparation of r-BHET Solution

r-BHET (644.0 g) and water (276.0 g) were uniformly mixed at atmospheric pressure (absolute pressure: 760.0 mmHg) and 60° C. to prepare a r-BHET solution (70 wt %).

### Step 2) Esterification Reaction

Into a reactor with a capacity of 10 L in which a column, and a condenser capable of cooling by water are connected, the above prepared r-BHET solution, and as monomers, TPA(3787.9 g), EG(1304.7 g), CHDM(255.6 g), DEG(185.1 g) were introduced. Further, TiO₂/SiO₂ copolymer (0.2 g) was introduced as a catalyst, phosphoric acid (0.8 g) as a stabilizer, and cobalt acetate (1.1 g) as a coloring agent.

Subsequently, nitrogen was introduced in the reactor to make a pressurized state where the pressure of the reactor is 1.0 kgf/cm² higher than atmospheric pressure (absolute pressure: 1495.6 mmHg). Further, the temperature of the reactor was raised to 220° C. over 90 minutes, and maintained at 220° C. for 2 hours, and then, raised to 250° C. over 2 hours. And then, the mixture in the reactor was observed with the naked eye, and until the mixture became transparent, while maintaining the temperature of the reactor at 250° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 740 mL, the valve was closed so that by-products may not be additionally discharged in the esterification reaction. As described below, the amount (740 mL) of discharged by-products was the amount controlled to 70% of the total amount of discharged by-products in the total reaction (esterification reaction of step 2 and polycondensation reaction of step 3) of Example 4.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 265° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.56 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 317 mL.

### Step 4) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 220° C. at a speed of 40° C./hour, and maintained at 220° C. The solid-state polymerization reaction was progressed until the intrinsic viscosity (IV) of the particles in the reactor became 0.85 dl/g, thus preparing polyester copolymer.

### Example 5

Step 1) r-BHET Solution

r-BHET (3956.4 g) and water (3956.4 g) were uniformed mixed at a pressure 2.0 kgf/cm² higher than atmospheric pressure (absolute pressure: 2231.1 mmHg) and 80° C. to prepare a r-BHET solution (50 wt %).

### Step 2) Esterification Reaction

Into a reactor with a capacity of 10 L in which a column, and a condenser capable of cooling by water are connected, the above prepared r-BHET solution, and as monomers, TPA(456.3 g), EG(113.6 g), CHDM(791.6 g) were introduced. Further, GeO₂ (5.1 g) was introduced as a catalyst, cobalt acetate (0.5 g) as a coloring agent, Polysynthren Blue RLS(Clarient, 0.002 g) as blue toner, and Solvaperm Red BB(Clarient, 0.001 g) as red toner.

Subsequently, nitrogen was introduced in the reactor to make a pressurized state where the pressure of the reactor is 2.0 kgf/cm² higher than atmospheric pressure (absolute pressure: 2231.1 mmHg). Further, the temperature of the reactor was raised to 220° C. over 90 minutes, and maintained at 220° C. for 2 hours, and then, raised to 255° C. over 2 hours. And then, the mixture in the reactor was observed with the naked eye, and until the mixture became transparent, while maintaining the temperature of the reactor at 255° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 540 mL, the valve was closed so that by-products may not be additionally discharged in the esterification reaction. As described below, the amount (540 mL) of discharged by-products was the amount controlled to 40% of the total amount of discharged by-products in the total reaction (esterification reaction of step 2 and polycondensation reaction of step 3) of Example 5.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 285° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.70 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 810 mL.

### Example 6

Step 1) Preparation of r-BHET Solution

r-BHET (2368.4 g) and water (1579.0 g) were uniformed mixed at a pressure 1.5 kgf/cm² higher than atmospheric pressure (absolute pressure: 1863.4 mmHg) and 90° C. to prepare a r-BHET solution (60 wt %).

### Step 2) Esterification Reaction

Into a reactor with a capacity of 10 L in which a column, and a condenser capable of cooling by water are connected, the above prepared r-BHET solution, and as monomers, TPA(1266.4 g), EG(199.7 g), CHDM(756.8 g), DEG(247.5 g) were introduced. Further, TiO₂/SiO₂ copolymer (0.1 g) was introduced as a catalyst, and cobalt acetate (1.0 g) was introduced as a coloring agent.

Subsequently, nitrogen was introduced in the reactor to make a pressurized state where the pressure of the reactor is 1.5 kgf/cm² higher than atmospheric pressure (absolute pressure: 1127.8 mmHg). Further, the temperature of the reactor was raised to 220° C. over 90 minutes, and maintained at 220° C. for 2 hours, and then, raised to 250° C. over 2 hours. And then, the mixture in the reactor was observed with the naked eye, and until the mixture became transparent, while maintaining the temperature of the reactor at 250° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 506 mL, the valve was closed so that by-products may not be additionally discharged in the esterification reaction. As described below, the amount (506 mL) of discharged by-products was the amount controlled to 50% of the total amount of discharged by-products in the total reaction (esterification reaction of step 2 and polycondensation reaction of step 3) of Example 6.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 270° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.80 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 506 mL.

### Example 7

Step 1) Preparation of r-BHET Solution

r-BHET (1195.3 g) and water (132.0 g) were uniformed mixed at a pressure 1.5 kgf/cm² higher than atmospheric pressure (absolute pressure: 1863.4 mmHg) and 110° C. to prepare a r-BHET solution (90 wt %).

### Step 2) Esterification Reaction

Into a reactor with a capacity of 10 L in which a column, and a condenser capable of cooling by water are connected, the above prepared r-BHET solution, and as monomers, TPA(2343.6 g), CHDM(1355.3 g), ISB(824.5 g), DEG(274.8 g) were introduced. Further, GeO₂ (26.9 g) was introduced as a catalyst, phosphoric acid (0.2 g) as a stabilizer, Polysynthren Blue RLS(Clarient, 0.013 g) as blue toner, and Solvaperm Red BB(Clarient, 0.004 g) as red toner.

Subsequently, nitrogen was introduced in the reactor to make a pressurized state where the pressure of the reactor is 1.0 kgf/cm² higher than atmospheric pressure (absolute pressure: 1495.6 mmHg). Further, the temperature of the reactor was raised to 220° C. over 90 minutes, and maintained at 220° C. for 2 hours, and then, raised to 265° C. over 2 hours. And then, the mixture in the reactor was observed with the naked eye, and until the mixture became transparent, while maintaining the temperature of the reactor at 265° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 627 mL, the valve was closed so that by-products may not be additionally discharged in the esterification reaction. As described below, the amount (627 mL) of discharged by-products was the amount controlled to 55% of the total amount of discharged by-products in the total reaction (esterification reaction of step 2 and polycondensation reaction of step 3) of Example 7.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 275° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.65 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 513 mL.

### Example 8

Step 1) Preparation of r-BHET Solution

r-BHET (420.4 g) and water (180.2 g) were uniformed mixed at a pressure 2.0 kgf/cm² higher than atmospheric pressure (absolute pressure: 2231.1 mmHg) and 85° C. to prepare a r-BHET solution (70 wt %).

### Step 2) Esterification Reaction

Into a reactor with a capacity of 10 L in which a column, and a condenser capable of cooling by water are connected, the above prepared r-BHET solution, and as monomers, TPA(2778.1 g), EG(764.1 g), CHDM(211.9 g), DEG(295.4 g), CHDM derivatives (161.1 g; comprising i) 4-(hydroxymethyl)cyclohexylmethyl 4-(hydroxymethyl)cyclohexanecarboxylate, and ii) 4-(4-(hydroxymethyl)cyclohexylmethoxymethyl)cyclohexylmethanol at a mole ratio of 1:3) were introduced. Further, GeO₂ (2.5 g) was introduced as a catalyst, phosphoric acid (0.8 g) as a stabilizer, Polysynthren Blue RLS(Clarient, 0.020 g) as blue toner, and Solvaperm Red BB(Clarient, 0.008 g) as red toner.

Subsequently, nitrogen was introduced in the reactor to make a pressurized state where the pressure of the reactor is 0.5 kgf/cm² higher than atmospheric pressure (absolute pressure: 1127.8 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 537 mL, the valve was closed so that by-products may not be additionally discharged in the esterification reaction. As described below, the amount (537 mL) of discharged by-products was the amount controlled to 75% of the total amount of discharged by-products in the total reaction (esterification reaction of step 2 and polycondensation reaction of step 3) of Example 8.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 275° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.80 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 179 mL.

### Example 9

Step 1) Preparation of r-BHET Solution

r-BHET (3486.5 g) and water (2852.6 g) were uniformly mixed at atmospheric pressure (absolute pressure: 760.0 mmHg) and 83° C. to prepare a r-BHET solution (55 wt %).

### Step 2) Esterification Reaction

Into a reactor with a capacity of 10 L in which a column, and a condenser capable of cooling by water are connected, the above prepared r-BHET solution, and as monomers, TPA(976.5 g), IPA (isophthalic acid; 2278.5 g), EG(693.0 g), CHDM(112.9 g), ISB(114.5 g), DEG(143.1 g) were introduced. Further, TiO₂/SiO₂ copolymer (0.3 g) was introduced as a catalyst, phosphoric acid (15.0 g) as a stabilizer, and cobalt acetate (0.7 g) as a coloring agent.

Subsequently, nitrogen was introduced in the reactor to make a pressurized state where the pressure of the reactor is 3.0 kgf/cm² higher than atmospheric pressure (absolute pressure: 2956.7 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 944 mL, the valve was closed so that by-products may not be additionally discharged in the esterification reaction. As described below, the amount (944 mL) of discharged by-products was the amount controlled to 60% of the total amount of discharged by-products in the total reaction (esterification reaction of step 2 and polycondensation reaction of step 3) of Example 9.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 280° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.60 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 629 mL.

### Step 4) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 190° C. at a speed of 40° C./hour, and maintained at 190° C. The solid-state polymerization reaction was progressed until the intrinsic viscosity (IV) of the particles in the reactor became 1.00 dl/g, thus preparing polyester copolymer.

### Comparative Example 1

### Step 1) Esterification Reaction

Into a reactor with a capacity of 10 L in which a column, and a condenser capable of cooling by water are connected, r-BHET powder (1515.0 g), and as monomers, TPA(2310.3 g), EG(980.0 g), CHDM(57.3 g), ISB(101.6 g) were introduced. Further, GeO₂ (4.9 g) was introduced as a catalyst.

Subsequently, nitrogen was introduced in the reactor to make a pressurized state where the pressure of the reactor is 0.5 kgf/cm² higher than atmospheric pressure (absolute pressure: 1127.8 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 323 mL, the valve was closed so that by-products may not be additionally discharged in the esterification reaction. As described below, the amount (323 mL) of discharged by-products was the amount controlled to 30% of the total amount of discharged by-products in the total reaction (esterification reaction of step 2 and polycondensation reaction of step 3) of Comparative Example 1.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 2) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 280° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.60 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 753 mL.

### Step 3) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 200° C. at a speed of 40° C./hour, and maintained at 200° C. The solid-state polymerization reaction was progressed until the intrinsic viscosity (IV) of the particles in the reactor became 0.70 dl/g, thus preparing polyester copolymer.

### Comparative Example 2

Step 1) Preparation of r-BHET Molten Solution

r-BHET (1561.1 g) was molten at 130° C. to prepare a molten solution of r-BHET.

### Step 2) Esterification Reaction

Into a reactor with a capacity of 10 L in which a column, and a condenser capable of cooling by water are connected, the above prepared r-BHET molten solution, and as monomers, TPA(2381.3 g), EG(1594.6 g), CHDM(295.1 g), ISB(104.7 g), DEG(29.9 g) were introduced. Further, TiO₂/SiO₂ copolymer (0.1 g) was introduced as a catalyst, and cobalt acetate (0.7 g) as a coloring agent.

Subsequently, nitrogen was introduced in the reactor to make a pressurized state where the pressure of the reactor is 1.0 kgf/cm² higher than atmospheric pressure (absolute pressure: 1495.6 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 633 mL, the valve was closed so that by-products may not be additionally discharged in the esterification reaction. As described below, the amount (633 mL) of discharged by-products was the amount controlled to 35% of the total amount of discharged by-products in the total reaction (esterification reaction of step 2 and polycondensation reaction of step 3) of Comparative Example 2.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 280° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.60 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 1176 mL.

### Step 4) Solid-State Polymerization Reaction

The particles were left at 150° C. for 1 hour to crystallize, and then, introduced into a solid-state polymerization reactor with a capacity of 20 L. And then, nitrogen was flowed to the reactor at a speed of 50 L/min. At this time, the temperature of the reactor was increased from room temperature to 140° C. at a speed of 40° C./hour, and maintained at 140° C. for 3 hours, and then, increased to 200° C. at a speed of 40° C./hour, and maintained at 200° C. The solid-state polymerization reaction was progressed until the intrinsic viscosity (IV) of the particles in the reactor became 0.95 dl/g, thus preparing polyester copolymer.

### Comparative Example 3

Step 1) Preparation of r-BHET Solution

r-BHET (304.1 g) and water (1216.6 g) were uniformed mixed at a pressure 0.5 kgf/cm² higher than atmospheric pressure (absolute pressure: 1127.8 mmHg) and 40° C. to prepare a r-BHET solution (20 wt %).

### Step 2) Esterification Reaction

Into a reactor with a capacity of 10 L in which a column, and a condenser capable of cooling by water are connected, the above prepared r-BHET solution, and as monomers, TPA(2640.8 g), EG(572.7 g), CHDM(1231.6 g), ISB(25.0 g), DEG(25.0 g) were introduced. Further, GeO₂ (2.6 g) was introduced as a catalyst, phosphoric acid (0.1 g) as a stabilizer, Polysynthren Blue RLS(Clarient, 0.012 g) as blue toner, and Solvaperm Red BB(Clarient, 0.004 g) as red toner.

Subsequently, nitrogen was introduced in the reactor to make a pressurized state where the pressure of the reactor is 0.5 kgf/cm² higher than atmospheric pressure (absolute pressure: 1127.8 mmHg). Further, the temperature of the reactor was raised to 220° C. over 90 minutes, and maintained at 220° C. for 2 hours, and then, raised to 255° C. over 2 hours. And then, the mixture in the reactor was observed with the naked eye, and until the mixture became transparent, while maintaining the temperature of the reactor at 255° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 711 mL, the valve was closed so that by-products may not be additionally discharged in the esterification reaction. As described below, the amount (711 mL) of discharged by-products was the amount controlled to 90% of the total amount of discharged by-products in the total reaction (esterification reaction of step 2 and polycondensation reaction of step 3) of Comparative Example 3.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 280° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.55 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 79 mL.

### Comparative Example 4

Step 1) Preparation of r-BHET Solution

r-BHET (3193.6 g) and water (3903.3 g) were uniformed mixed at a pressure 1.0 kgf/cm² higher than atmospheric pressure (absolute pressure: 1495.6 mmHg) and 60° C. to prepare a r-BHET solution (45 wt %).

### Step 2) Esterification Reaction

Into a reactor with a capacity of 10 L in which a column, and a condenser capable of cooling by water are connected, the above prepared r-BHET solution, and as monomers, TPA(623.4 g), EG(283.5 g), ISB(95.4 g), DEG(95.4 g) were introduced. Further, TiO₂/SiO₂ copolymer (0.1 g) was introduced as a catalyst, phosphoric acid (0.4 g) as a stabilizer, Polysynthren Blue RLS(Clarient, 0.010 g) as blue toner, and Solvaperm Red BB(Clarient, 0.003 g) as red toner.

Subsequently, nitrogen was introduced in the reactor to make a pressurized state where the pressure of the reactor is 0.1 kgf/cm² higher than atmospheric pressure (absolute pressure: 2956.7 mmHg). Further, the temperature of the reactor was raised to 220° C. over 90 minutes, and maintained at 220° C. for 2 hours, and then, raised to 260° C. over 2 hours. And then, the mixture in the reactor was observed with the naked eye, and until the mixture became transparent, while maintaining the temperature of the reactor at 260° C., an esterification reaction was progressed for 245 minutes. During this process, by-products were discharged through the column and condenser, and the discharge of by-products was specifically controlled as follows.

After the temperature reached 220° C. in the esterification reaction, the lower valve of the column was opened to discharge by-products (unreacted monomers, water by-products) in the pre-polymer step, and if the amount of discharged by-products became 107 mL, the valve was closed so that by-products may not be additionally discharged in the esterification reaction. As described below, the amount (107 mL) of discharged by-products was the amount controlled to 10% of the total amount of discharged by-products in the total reaction (esterification reaction of step 2 and polycondensation reaction of step 3) of Comparative Example 4.

After the esterification reaction was completed, nitrogen inside the reactor of a pressurized state was discharged outside to lower the pressure of the reactor to atmospheric pressure, and then, the mixture in the reactor was transferred to a reactor with a capacity of 7 L where a vacuum reaction can be progressed.

### Step 3) Polycondensation Reaction

The pressure of the reactor with a capacity of 7 L was lowered from atmospheric pressure state to 5 Torr (absolute pressure: 5 mmHg) over 30 minutes, and simultaneously, the temperature of the reactor was raised to 270° C. over 1 hour, and while maintaining the pressure of the reactor at 1 Torr (absolute pressure: 1 mmHg) or less, a polycondensation reaction was conducted. At the beginning of the polycondensation reaction, a stirring speed was set rapid, but if stirring force decreases or the temperature of the reactant increases over predetermined temperature due to viscosity increase of the reactant with the progression of the polycondensation reaction, the stirring speed may be appropriately controlled. The polycondensation reaction was progressed until intrinsic viscosity (IV) of the mixture (molten material) in the reactor became 0.40 dl/g. If the intrinsic viscosity of the mixture in the reactor reached a desired level, the mixture was discharged outside the reactor and stranded, and it was solidified with a coolant, and then, granulated such that the average weight became about 12 to 14 mg. After the polycondensation reaction was completed, the amount of by-products additionally generated in polycondensation was confirmed to be 960 mL.

### Experimental Example

For the copolymers prepared in Examples and Comparative Examples, the properties were evaluated as follows.

### 1) Residue Composition

The compositions (mol %) of residues derived from acid and diol in the polyester resin were confirmed through 1H-NMR spectrum obtained at 25° C. using nuclear magnetic resonance device (JEOL, 600 MHZ FT-NMR), after dissolving a sample in a CDCl₃ solvent at the concentration of 3 mg/mL. Further, TMA residues were confirmed by quantitative analysis through spectrum measuring the content of benzene-1,2,4-triethylcarboxylate produced by the reaction of ethanol and TMA through ethanolysis at 250° C. using gas chromatography (Agilent Technologies, 7890B), and confirmed as the content (wt %) based on the total weight of polyester resin.

### 2) Intrinsic Viscosity

Intrinsic viscosity was measured using Ubbelohde viscometer in a 35° C. thermostat, after dissolving polyester copolymer in 150° C. orthochlorophenol (OCP) at the concentration of 0.12%. Specifically, the temperature of the tube viscometer was maintained at 35° C., and a time t₀ (efflux time) taken for the solvent to pass between specific internal sections of the tube viscometer, and a time t taken for the solution to pass therebetween were calculated. And then, the t₀ value and t value were substituted into Equation 1 to calculate specific viscosity, and the specific viscosity value was substituted into Equation 2 to calculate intrinsic viscosity.

$${η}_{sp} = \frac{t - {t}_{0}}{{t}_{0}} \qquad [ Equation 1 ]$$

$$[ η ] = \frac{\sqrt{1 + 4 A {η}_{sp}} - 1}{2 Ac} \qquad [ Equation 2 ]$$

### 3) High Molecular Weight Content

After the esterification reaction in each Example and Comparative Example, the number average molecular weight of prepared oligomer was confirmed, and high molecular weight content in oligomer was defined as follows.

High molecular weight content (%)=(the area % of oligomer having number average molecular weight of 1,000 or more/total area %)×100

The number average molecular weight was measured with copolyester resin dissolved in o-CP orthochlrophenol (OCP), and GPC (gel permeation gas chromatography) and polystyrene standard (Shodex SM-105′, Showa Denko, Japan) were used, and pre-treatment conditions and measurement conditions were as follows.
Pre-treatment conditions: 150° C., 15 minutes, after dissolving with 3 ml of OCP, adding CHCl₃ (9 ml) at room temperature
Measurement conditions: measured under conditions of solvent OCP:CHCl₃ 1:3 (v:v), column temperature 40° C., flow rate 0.7 mlL/min, to confirm oligomer molecule distribution according to time, and obtain high molecular weight content value therefrom.

### 4) Productivity

In each Example and Comparative Example, productivity was defined as follows.

$$Productivity ( \% ) = ( esterification reaction time ) / ( polycondensation reaction time ) \times 100$$

Wherein, ‘esterification reaction time’ and ‘polycondensation reaction time’ respectively mean a time (hr) for which corresponding reaction is progressed in each Example and Comparative Example. For example, in the case of Example 1, they mean a time for which the esterification reaction of step 2 was progressed, and a time for which the polycondensation reaction of step 3 was progressed.

The results were shown in the following Tables 1 and 2.

TABLE 1

| | | | | | CHDM | | | Intrinsic |
|---|---|---|---|---|---|---|---|---|
| | r-BHET | DEG | ISB | CHDM | derivatives | TPA | IPA | viscosity |
| unit | wt % | mol % | mol % | mol % | mol % | mol % | mol % | dl/g |
| Ex. 1 | 35 | 1 | 2 | 10 | 0 | 100 | 0 | 1.00 |
| Ex. 2 | 95 | 2 | 1 | 4 | 0 | 100 | 0 | 0.85 |
| Ex. 3 | 78 | 5 | 0 | 2 | 0 | 100 | 0 | 0.80 |
| Ex. 4 | 12 | 5 | 0 | 7 | 0 | 100 | 0 | 0.85 |
| Ex. 5 | 70 | 2 | 0 | 30 | 0 | 100 | 0 | 0.70 |
| Ex. 6 | 46 | 8 | 0 | 31 | 0 | 100 | 0 | 0.80 |
| Ex. 7 | 21 | 3 | 20 | 50 | 0 | 100 | 0 | 0.65 |
| Ex. 8 | 10 | 11.5 | 0 | 14.5 | 4 | 100 | 0 | 0.80 |
| Ex. 9 | 66 | 2 | 1 | 4 | 0 | 50 | 50 | 0.60 |
| Comparative | 33 | 0 | 1 | 2 | 0 | 100 | 0 | 0.70 |
| Ex. 1 | | | | | | | | |
| Comparative | 28 | 1 | 2 | 10 | 0 | 100 | 0 | 0.95 |
| Ex. 2 | | | | | | | | |
| Comparative | 7 | 1 | 1 | 50 | 0 | 100 | 0 | 0.55 |
| Ex. 3 | | | | | | | | |
| Comparative | 77 | 4 | 4 | 0 | 0 | 100 | 0 | 0.40 |
| Ex. 4 | | | | | | | | |

TABLE 2

| | | | | | High | |
|---|---|---|---|---|---|---|
| | | | By-product discharge | | molecular | |
| | r-BHET dissolution | | | PES | weight | |
| | Dissolution | concentration | Prepolymer | melt | content | |
| | temperature | (%) | step | step | (GPC) | Productivity |
| unit | ° C. | % | % | % | % | % |
| Ex. 1 | 85 | 90 | 50% | 50% | 62% | 100% |
| Ex. 2 | 90 | 80 | 30% | 70% | 45% | 100% |
| Ex. 3 | 120 | 95 | 35% | 65% | 32% | 150% |
| Ex. 4 | 60 | 70 | 70% | 30% | 70% | 90% |
| Ex. 5 | 80 | 50 | 40% | 60% | 45% | 120% |
| Ex. 6 | 90 | 60 | 50% | 50% | 75% | 90% |
| Ex. 7 | 110 | 90 | 55% | 45% | 65% | 100% |
| Ex. 8 | 85 | 70 | 85% | 15% | 40% | 115% |
| Ex. 9 | 83 | 55 | 60% | 40% | 52% | 85% |
| Comparative | — | — | 20% | 80% | 30% | 80% |
| Ex. 1 | | | | | | |
| Comparative | 130¹⁾ | — | 35% | 65% | 25% | 75% |
| Ex. 2 | | | | | | |
| Comparative | 40 | 20 | 90% | 10% | 17% | 40% |
| Ex. 3 | | | | | | |
| Comparative | 60 | 45 | 10% | 90% | 20% | 50% |
| Ex. 4 | | | | | | |

¹⁾melting temperature

As shown in Table 2, it can be confirmed that the polyester polymer prepared according to the present disclosure has high content of high molecular weights, and high productivity.

Particularly, it was confirmed that as in Comparative Example 1, 3 and 4, in case the rate of by-product discharge in prepolymer step is less than 30% or greater than 85%, the content of high molecular weights was 30% or less, resulting in productivity decrease. Although not theoretically limited, if the rate of by-product discharge in prepolymer step is less than 30%, by-products may not be sufficiently discharged outside the reaction system, rendering high viscosity reaction impossible, and if the rate of by-product discharge in prepolymer step is greater than 85%, due to excessive monomer (particularly, glycol) loss, a polymerization reaction may not sufficiently occur.

Thus, it was confirmed that by controlling the by-product discharge rate in prepolymer step as described herein, high viscosity reaction is enabled and productivity may be also increased.

What is claimed is:

1. A method for preparing polyester copolymer comprising steps of:
1) mixing bis-2-hydroxyethyl terephthalate and water at a temperature of 60 to 120° C. and a pressure of 0.5 to 3.5 kg/cm² to prepare an aqueous solution of bis-2-hydroxyethyl terephthalate (step 1);
2) subjecting the following components to an esterification reaction to prepare oligomer (step 2);
i) the aqueous solution comprising bis-2-hydroxyethyl terephthalate of step 1,
ii) dicarboxylic acid or derivatives thereof,
iii) ethylene glycol or diethylene glycol, and
iv) diol-based comonomers; and
3) conducting polycondensation of the oligomer of step 2 to prepare polyester copolymer (step 3),
wherein the amounts of by-products discharged in the steps 2 and 3 meet the following Mathematical Formula 1:
0.30≤A/(A+B)≤0.85 [Mathematical Formula 1]
in the Mathematical Formula 1,
A is the volume (mL) of the by-products discharged in the step 2, and
B is the volume (mL) of the by-products discharged in the step 3.

2. The method according to claim 1, wherein
the concentration of the bis-2-hydroxyethyl terephthalate aqueous solution prepared in the step 1 is 50 to 95%.

3. The method according to claim 1, wherein
the dicarboxylic acid comprises terephthalic acid or isophthalic acid.

4. The method according to claim 1, wherein
the diol-based comonomers comprise cyclohexanedimethanol, cyclohexanedimethanol derivatives, or isosorbide.

5. The method according to claim 4, wherein
the cyclohexanedimethanol derivative is 4-(hyroxymethyl)cyclohexylmethyl 4-(hydroxymethyl)cyclohexane carboxylate, or 4-(4-(hydroxymethyl)cyclohexylmethoxymethyl)cyclohexylmethanol.

6. The method according to claim 4, wherein
the diol-based comonomers further comprise 1,2-propanediol, 1,3-propanediol, 2-methyl-1,3-propanediol, 2-methylene-1,3-propanediol, 2-ethyl-1,3-propanediol, 2-isopropyl-1,3-propanediol, 2,2-dimethyl-1,3-propanediol, 1,4-butanediol, 2,3-butanediol, 3-methyl-1,5-pentanediol, 3-methyl-2,4-pentanediol, 1,6-hexanediol, 1,2-cyclohexanediol, or 1,4-cyclohexanediol.

7. The method according to claim 1, wherein
the esterification reaction of the step 2 is conducted at a temperature of 200 to 300° C. and a pressure of 0.5 to 3.5 kg/cm².

8. The method according to claim 1, wherein
the polycondensation reaction of the step 3 is conducted at a temperature of 240 to 300° C. and a pressure of 400 to 0.01 mmHg.

9. The method according to claim 1, further comprising a step of conducting solid-state polymerization of the polyester copolymer prepared in the step 3.

10. The method according to claim 9, wherein
the solid-state polymerization is conducted at 150 to 220° C.

11. The method according to claim 1, wherein
the polyester copolymer has intrinsic viscosity of 0.50 to 1.0 dl/g.

12. The method according to claim 1, wherein
the polyester copolymer comprises repeat units derived from bis-2-hydroxyethyl terephthalate in the content of 5 wt % to 99 wt %, based on the weight of the polyester copolymer.
